(19) United States
(12) Patent Application Publication
(10) Pub. No.: US 2020/0300594 A1
(43) Pub. Date: Sep. 24, 2020

(54) ELECTROFUSION MEASURING DEVICE

(71) Applicant: Michael Louis Argauer, East Aurora, NY (US)

(72) Inventor: Michael Louis Argauer, East Aurora, NY (US)

(21) Appl. No.: 16/811,698

(22) Filed: Mar. 6, 2020

Related U.S. Application Data
(60) Provisional application No. 62/820,265, filed on Mar. 19, 2019.

(51) Int. Cl. G01B 3/04; G01B 5/02; G01B 3/56; G01B 5/24

(52) U.S. Cl. CPC G01B 3/04; G01B 5/24; G01B 3/563; G01B 5/02

(57) ABSTRACT

An electrofusion pipe measuring device, including a first section including a first edge and a second edge, a second section extending from the first section, the second section including a third edge arranged perpendicular to the first edge and a fourth edge, and a third section rotatably connected to one of the first section and the second section, the third section including a fifth edge and a sixth edge.

### CROSS-REFERENCE TO RELATED APPLICATIONS

This application claims the benefit under 35 U.S.C. § 119(e) of U.S. Provisional Application No. 62/820,265, filed Mar. 19, 2019, which application is incorporated herein by reference in its entirety.

### FIELD

The present disclosure relates generally to measuring devices, and more particularly, to a plastic pipe measuring device for measuring pipes and verifying their use for electrofusion.

### BACKGROUND

Electrofusion is a method of joining medium-density polyethylene (MDPE), high-density polyethylene (HDPE), and other plastic pipes using special fittings that have built-in electric heating elements which are used to weld the joint together. The pipes to be joined are cleaned, inserted into the electrofusion fitting (with a temporary clamp if required) and a voltage (typically 40V) is applied for a fixed time depending on the fitting in use. The built-in heater coils then melt the inside of the fitting and the outside of the pipe wall, which weld together producing a very strong homogeneous joint. The assembly is then left to cool for a specified time.

Electrofusion welding is beneficial because it does not require the operator to use dangerous or sophisticated equipment. After some preparation, the electrofusion welder will guide the operator through the steps to take. Welding heat and time is dependent on the type and size of the fitting. All electrofusion fittings are not created equal, that is, precise positioning of the energizing coils of wire in each fitting ensures uniform melting for a strong joint and the minimization of welding and cooling time.

The operator must be qualified according to local and national laws. Electrofusion welding training focuses on the importance of accurately fusing electrofusion fittings. Both manual and automatic methods of calculating electrofusion time gives operators the skills they need in the field. There is much to learn about the importance of preparation, timing, pressure, temperature, cool down time, and handling, etc. Training and certification are very important in this field of welding, as the product can become dangerous under certain circumstances. There has been cases of major harm and death, including when molten polyethylene spurts out of the edge of a mis-aligned weld, causing skin burns. Another case was due to a tapping saddle being incorrectly installed on a gas line, causing the death of the two welders in the trench due to gas inhalation. There are many critical parts to electrofusion welding that can cause weld failures, most of which can be greatly reduced by using welding clamps, and correct scraping equipment. To keep their qualification current, a trained operator can get their fitting tested, which involves cutting open the fitting and examining the integrity of the weld.

Additionally, there are a number of dimension requirements for pipes that are to be electrofused. For example, the wall thickness, the angle of the end (i.e., is the cut end of the pipe square), the roundness of the pipe end, the depth of any pit, gouge, groove, or ground down section (i.e., peeled section) on the pipe, etc. These dimension requirements can be burdensome to remember as well as measure.

Thus, there is a long felt need for a device the allows an operator to measure specific pipe dimensions and quickly determine if the pipe dimensions meet the requirements for electrofusion.

### SUMMARY

According to aspects illustrated herein, there is provided an electrofusion pipe measuring device, comprising a first section comprising a first edge and a second edge, a second section extending from the first section, the second section including a third edge arranged perpendicular to the first edge and a fourth edge, and a third section rotatably connected to one of the first section and the second section, the third section including a fifth edge and a sixth edge.

According to aspects illustrated herein, there is provided a measuring device for a pipe to be used for electrofusion, the measuring device comprising a first section comprising a first edge and a second edge, a second section extending from the first section, the second section including a third edge arranged perpendicular to the first edge, a fourth edge, a miter gauge including a first portion, a second portion, and a line separating the first portion and the second portion, and a pit gauge, a third section rotatably connected to one of the first section and the second section, the third section including a fifth edge and a sixth edge, the sixth edge operatively arranged to overlay the first portion, the line, or the second portion, and a fourth section rotatably connected to one of the first section and the second section, the fourth section including a seventh edge operatively arranged to overlay the pit gauge, and an eight edge comprising a protrusion extending therefrom.

According to aspects illustrated herein, there is provided a measuring device for a pipe to be used for electrofusion, the measuring device comprising a first section comprising a first edge and a second edge, the second edge including a plurality of slots, a second section comprising a third edge arranged perpendicular to the first edge, a fourth edge, a miter gauge, and a pit gauge, a third section rotatably connected to one of the first section and the second section, the third section comprising a fifth edge and a sixth edge, the sixth edge operatively arranged to overlay the miter gauge, and a fourth section rotatably connected to one of the first section and the second section, the third section comprising a seventh edge including a protrusion extending therefrom, and an eighth edge operatively arranged to overlay the pit gauge.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front perspective view of an electrofusion measuring device;

FIG. 2 is a front elevational view of the electrofusion measuring device shown in FIG. 1;

FIG. 3 is a detail view of the gauge taken generally along detail 3 in FIG. 2;

FIG. 4 is a detail view of the gauge taken generally along detail 4 in FIG. 2;

FIG. 5 is a rear elevational view of the electrofusion measuring device shown in FIG. 1;

FIG. 6A is a front perspective view of an electrofusion measuring device in engagement with a pipe;

FIG. 6B is a front elevational view of the electrofusion measuring device in engagement with the pipe, as shown in FIG. 6A;

FIG. 6C is a front elevational view of the electrofusion measuring device in engagement with the pipe, as shown in FIG. 6A;

FIG. 7A is a front perspective view of an electrofusion measuring device in engagement with a pipe;

FIG. 7B is a front elevational view of the electrofusion measuring device in engagement with the pipe, as shown in FIG. 7A; and,

FIG. 7C is a front elevational view of the electrofusion measuring device in engagement with the pipe, as shown in FIG. 7A.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

By “non-rotatably connected” elements, we mean that: the elements are connected so that whenever one of the elements rotate, all the elements rotate; and relative rotation between the elements is not possible. Radial and/or axial movement of non-rotatably connected elements with respect to each other is possible, but not required.

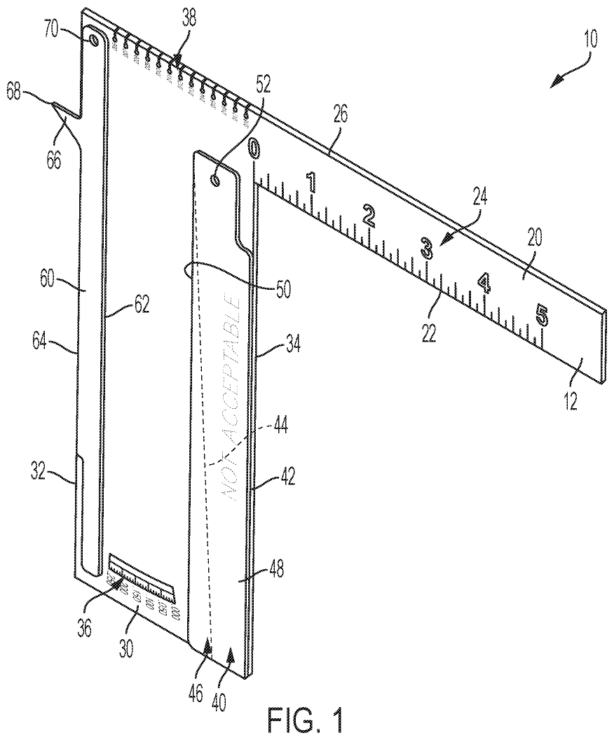

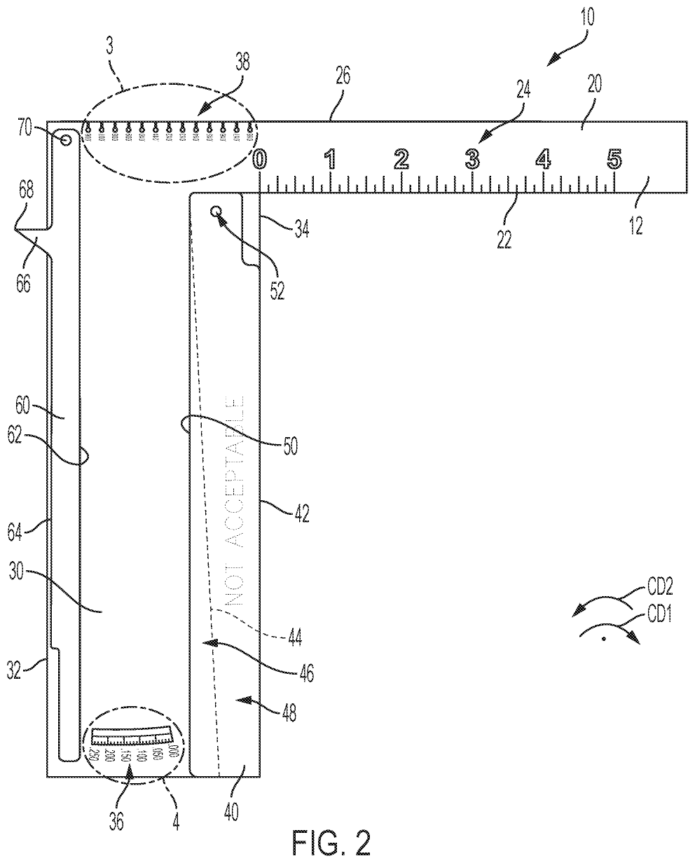

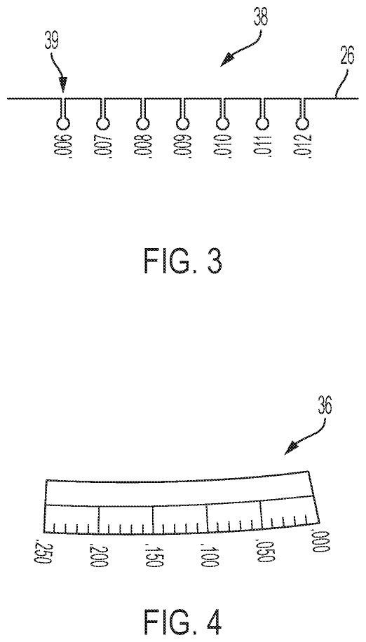

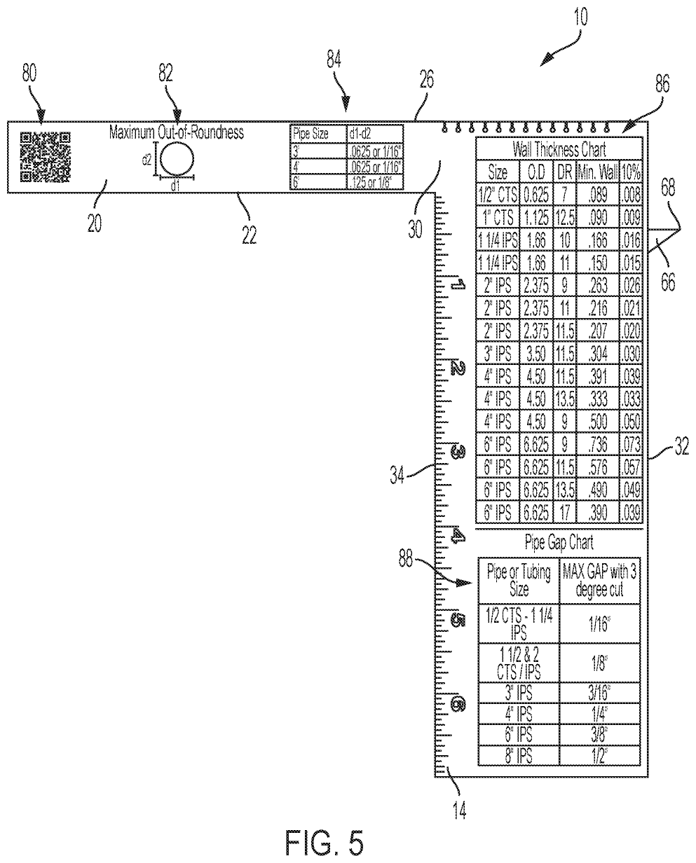

Adverting now to the figures, FIG. 1 is a front perspective view of electrofusion measuring device 10. FIG. 2 is a front elevational view of electrofusion measuring device 10. FIG. 3 is a detail view of gauge 38 taken generally along detail 3 in FIG. 2. FIG. 4 is a detail view of gauge 36 taken generally along detail 4 in FIG. 2. FIG. 5 is a rear elevational view of electrofusion measuring device 10. Electrofusion measuring device 10 generally comprises front surface 12, rear surface 14, section 20, section 30, section 40, and section 60. The following description should be read in view of FIGS. 1-7C.

Section 20 comprises edge 22 operatively arranged to engage a pipe and edge 26. Section 20 comprises gauge 24 on front surface 12. Gauge 24 may be, for example, a measuring device used to measure a diameter, length, wall thickness, etc. of a pipe. Gauge 24 may comprise a ruler in any standard measuring system units (e.g., U.S. customary units, metric units, imperial units, etc.). In some embodiments, electrofusion measuring device 10 comprises a length measuring gauge in addition to or instead of gauge 24, to be arranged on surface 14 of section 30 proximate edge 34. Section 20 may also comprise one or more references that may be utilized along with the various measuring features of electrofusion measuring device 10 to determine suitability of a pipe for electrofusion. For example, and as shown, section 20 may further comprise data code 80, reference 82, and/or table 84 on rear surface 14. It should be appreciated that data code 80, reference 82, and/or table 84 may be arranged anywhere on electrofusion measuring device 10, and that this disclosure should not be limited to arrangement only on section 20 or on surface 12.

Data code 80 comprises some scannable code that may be used to read information, for example, information about electrofusion measuring device 10 (e.g., instructions on how to use electrofusion measuring device 10, a website address, manufacturer information, information specific to an electrofusion job, etc.). Data code 80 may comprise a quick response (QR) code, a bar code, a near-field communication chip such as, for example, a radio-frequency identification (RFID) tag, etc.

Reference 82 comprises a chart illustrating measurements that should be taken on a pipe to ensure the pipe is suitably round for electrofusion. For example, if a pipe is too oblong, it should not be used for electrofusion. In the embodiment shown, reference 82 suggests that two diameter measurements should be taken of the pipe, the measurements being perpendicular to the other. After the proper diameter measurements of the pipe are taken, the dimensions are compared with table 84 to ensure the pipe is suitable for electro fusion. For example, if, on a 3″ pipe size, diameter d1 is 3.5″ and diameter d2 is 3.4″, then d1-d2 is 0.100″, which exceeds 0.0625″ as indicated in table 84 as the maximum allowable difference. Thus, that pipe should not be used for electrofusion as it is too oblong. It should be appreciated that reference 82 and table 84 may include any information or references, in any unit of measurement, suitable for the specific job type.

Section 30 is fixedly secured to section 20. In some embodiments, section 20 and section 30 are integrally formed. Section 30 comprises edge 32, edge 34, gauge 36, and gauge 38. Gauge 36 is operatively arranged to interact with section 60, as will be described in greater detail below. Section 30 further comprises, on surface 12, line 44 separating portion 46 from portion 48. Line 44 is arranged at an angle relative to edge 34, for example, 3 degrees. Line 44, portion 46, and portion 48 are operatively arranged to interact with section 40, as will be described in greater detail below.

As shown in the detail view of FIG. 3, gauge 38 comprises a plurality of slots 39 with each slot corresponding to a thickness. Gauge 38 is operatively arranged to measure the peel thickness from a pipe (i.e., gauge 38 is a peel thickness gauge). As is known in the art, prior to electrofusion, an outer layer of the pipe, proximate the end, must be peeled in order to remove a layer of oxidation. Generally, standards do not allow for the wall thickness to fall below 10% of its original thickness. Thus, the peeled off layer cannot be more than 10% of the original wall thickness. Electrofusion measuring device 10 allows the peeled layer to be inserted into each of the plurality of slots 39 until the thickness of the peeled layer is accurately determined. That thickness is then compared to a chart, for example, table 86 arranged on surface 14 to determine if the peeled layer is proper. For example, if the peeled layer of a 1″ copper tubing size (CTS) with a dimension ratio (DR) of 12.5 plastic pipe is 0.008″, the plastic pipe may be used since 0.008″ is less than 10% of the original wall thickness, or 0.009″. In another example, if the peeled layer of a 8″ iron pipe size (IPS)/ductile iron pipe size (DIPS) plastic pipe is 0.060″, the plastic pipe may not be used since 0.060″ is greater than 10% of the original wall thickness, or 0.050″. Each slot of slots 39 comprises a different width, which corresponds to a different peel thickness. For example, and as shown in FIG. 3, the width of each slot 39 increases from left to right (e.g., from 0.006″-0.012″). Current electrofusion guidelines require a minimum of 0.007″ thick layer be peeled from the pipe outer surface proximate end, to ensure total removal of the oxidation layer. Thus, gauge 38 is also capable of indicating whether this required minimum is met. For example, if a peeled section is 0.006″ inches thick, then another 0.001″ must be peeled from the pipe.

Section 40 is rotatably connected to section 30 or section 20 via connector 52. It should be appreciated that connector 52 may be any connecting device suitable for pivotably connecting section 40 with section 30 or 20, for example, a rivet, bolt, screw, pin, etc. Section 40 comprises edge 42 and edge 50. Edge 50 is operatively arranged to overlay portion 46, line 44, and portion 48. Section 40 is operatively arranged to measure the extent of any bevel at the end of a pipe to determine if the pipe is suitable for electrofusion, as will be described in greater detail below.

Section 60 is rotatably connected to section 20 or section 30 via connector 70. It should be appreciated that connector 70 may be any connecting device suitable for pivotably connecting section 60 with section 20 or 30, for example, a rivet, bolt, screw, pin, etc. Section 60 comprises edge 62, edge 64, and protrusion 66. Protrusion 66 extends from edge 64 and comprises tip 68. In some embodiments, protrusion 66 is generally triangular comprising a first side arranged perpendicular to edge 64 terminating at tip 68. Edge 62 is operatively arranged to overlay gauge 36. Section 60 is operatively arranged to measure the depth of a pit, gouge, scratch, peeled section, 46, line 44, and portion 48, as will be described in greater detail below.

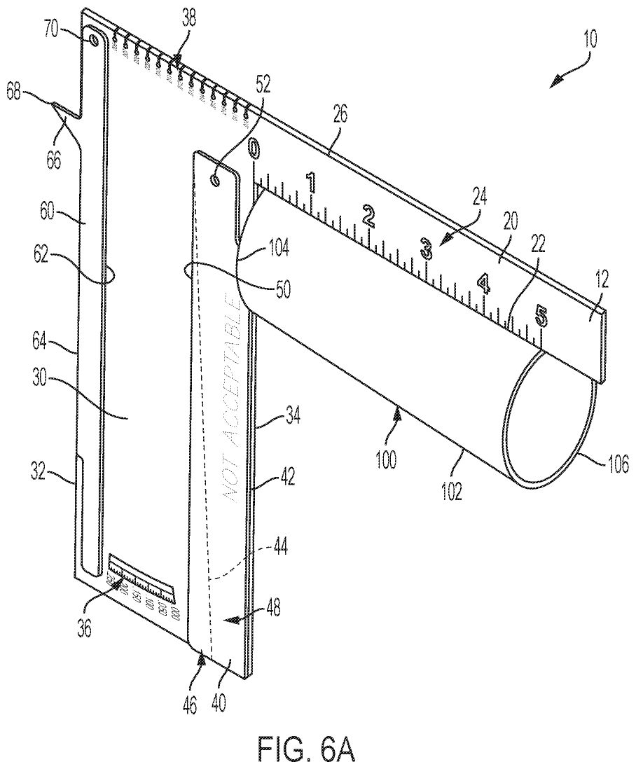

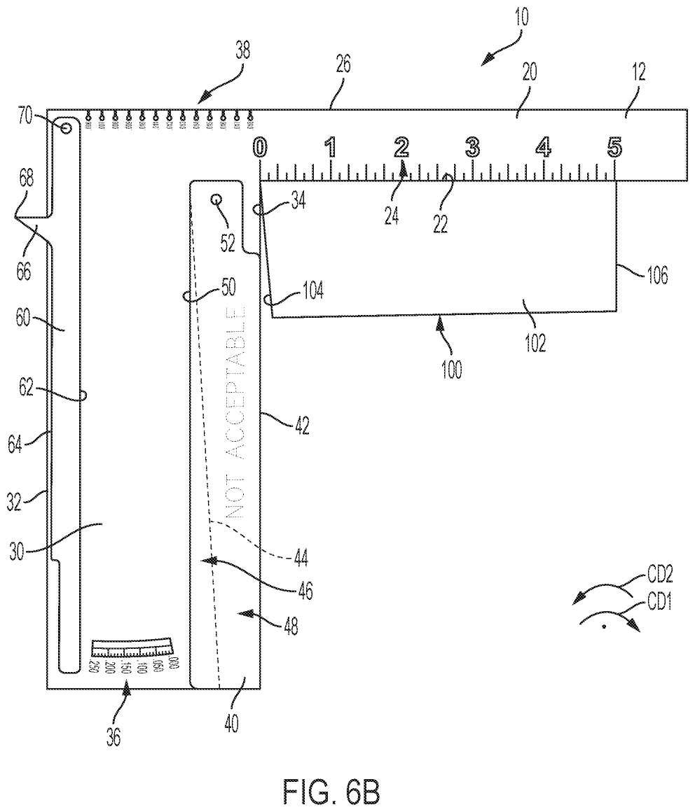

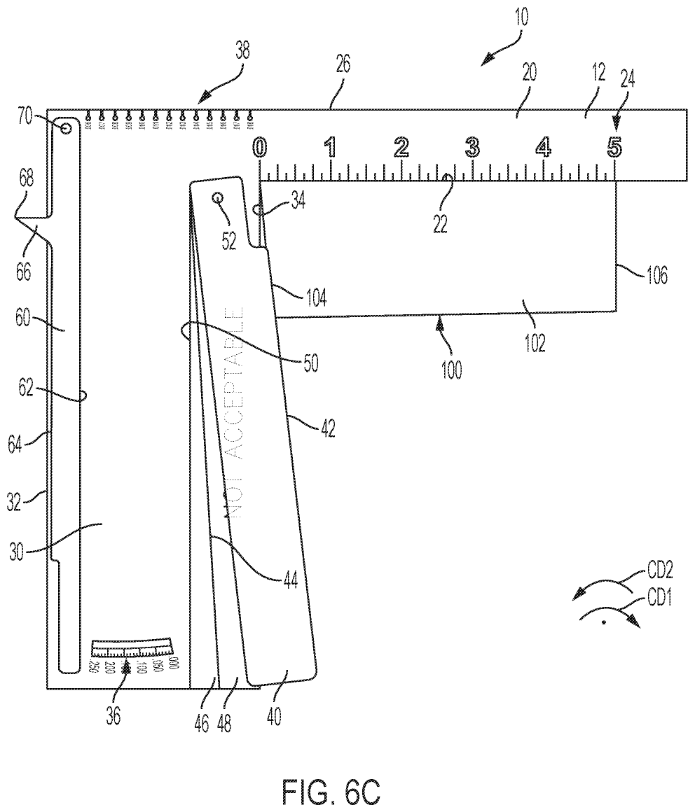

FIG. 6A is a front perspective view of electrofusion measuring device 10 in engagement with pipe 100. FIG. 6B is a front elevational view of electrofusion measuring device 10 in engagement with pipe 100. FIG. 6C is a front elevational view of electrofusion measuring device 10 in engagement with 100. The following description should be read in view of FIGS. 1-6C.

As previously described, section 40 is operatively arranged to indicate the maximum acceptable miter (e.g., ±3 degrees) and measure the end of a pipe with respect to such standard. Pipe 100 comprises radially outward facing surface 102, end 104, and 106. Pipe 100 is arranged such that the longest part of radially outward facing surface 102 abuts against edge 22 (see FIG. 6B). End 104 abuts against edge 34, again, at the longest part of pipe 100. Section 40 is then rotated in circumferential direction CD2 about connector 52 until edge 42 abuts against end 104, as shown in FIG. 6C. The user then observes where edge 50 is arranged in relation to surface 12. For example, and as shown in FIG. 6C, edge 50 overlays portion 48 arranged on the side of line 44 closest to edge 34, which indicates that the bevel in end 104 of pipe 100 is too great (i.e., end 104 is not square enough) for electrofusion and that the pipe should not be used. In some embodiments, edge 50 overlays portion 46 on the side of line 44 furthest from edge 34, which indicates that the bevel in end 104 of pipe is acceptable (i.e., end 104 is square enough) for electrofusion. In some embodiments, electrofusion measuring device 10 further comprises table 88 arranged on surface 14. Table 88 indicates the maximum allowable gap with respect to a ±3 degree cut or miter on the end of pipe 100. The max gap refers to, in trigonometry, the length of the opposite end of a right triangle having a 3-degree angle. Thus, in case section 40 was not properly working, a ruler could be used to determine whether the pipe miter was suitable for electrofusion.

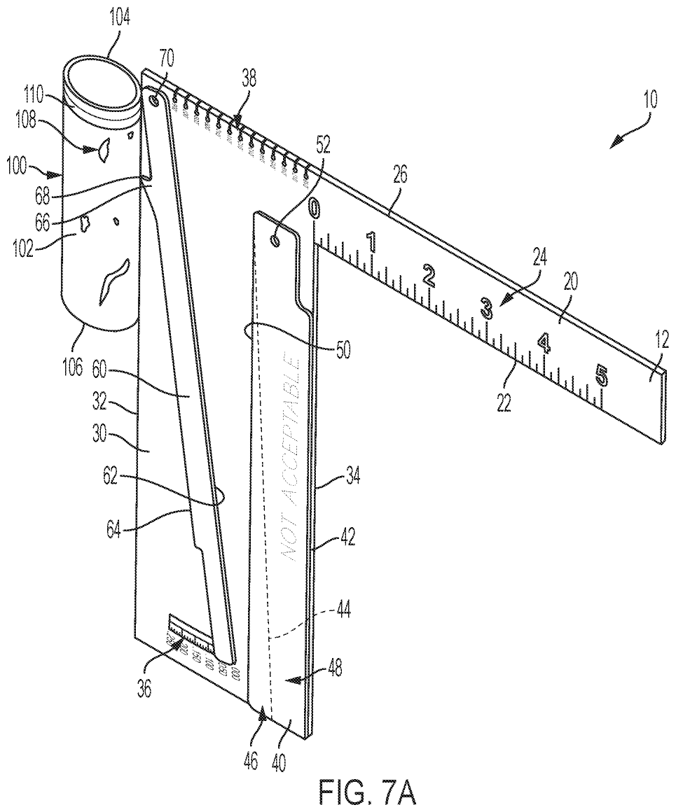

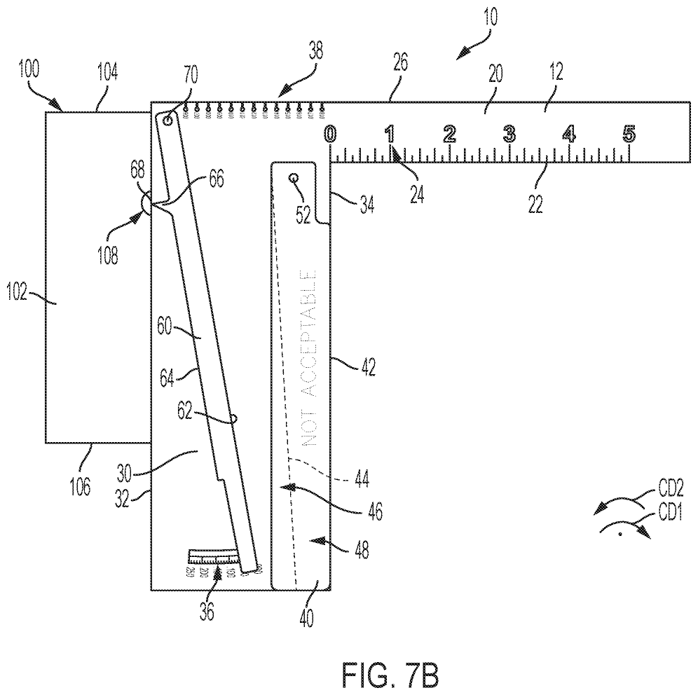

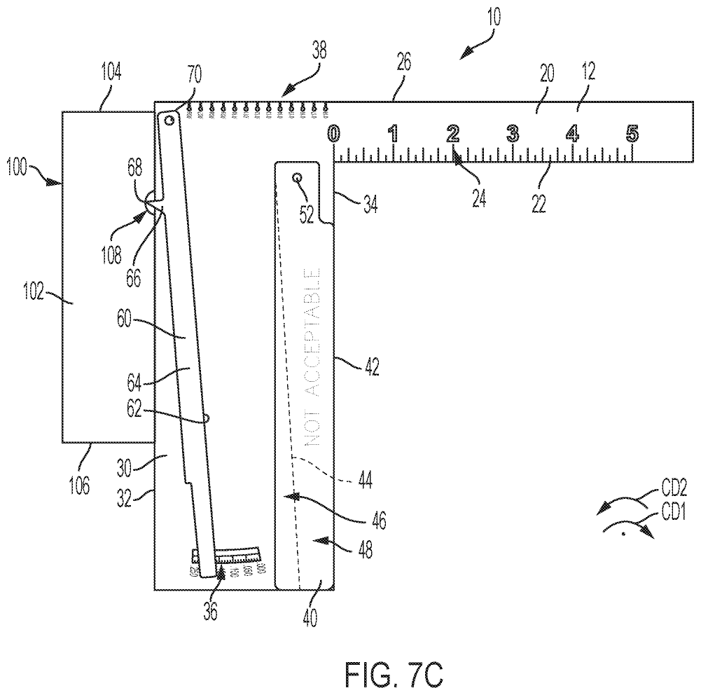

FIG. 7A is a front perspective view of electrofusion measuring device 10 in engagement with pipe 100. FIG. 7B is a front elevational view of electrofusion measuring device 10 in engagement with pipe 10. FIG. 7C is a front elevational view of electrofusion measuring device 10 in engagement with pipe 100, as shown in FIG. 7A. The following description should be read in view of FIGS. 1-7A.

As previously described, section 60 is operatively arranged to measure and indicate the depth of pit, scratch, and/or gouge 108, or peeled or ground down section 110, or any imperfection in radially outward facing surface 102 of the pipe 100. The measured depth is then compared to the minimum acceptable wall thickness, for example, shown in table 86. Pipe 100 is arranged such that radially outward facing surface 102 abuts against edge 32 (see FIG. 7A-B). Section 60 is then rotated in circumferential direction CD1 about connector 70 until tip 68 of protrusion 66 extends into the deepest portion of gouge 108 (or pit, scratch, peeled section, etc.), as shown in FIG. 7C. The user then observes where edge 62 is arranged in relation to surface 12. For example, and as shown in FIG. 7C, edge 62 overlays a portion of gauge 36 indicating the depth of gouge 108. The depth is then compared to the depth chart shown in table 86 on surface 14. For example, if pipe 100 is a 1.250″ IPS plastic pipe with gouge 108 having a maximum depth of 0.020″, then that pipe cannot be used because the depth of the gouge, 0.020″, exceeds 10% of the wall thickness, 0.016″. In another example, if pipe 100 is a 4″ IPS plastic pipe with a 13.5 dimension ratio, with peeled section 110 having a maximum depth of 0.030″, then the pipe may be used because the depth of the peeled section, 0.030″, is less than 10% of the wall thickness, 0.033″.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Electrofusion measuring device
12 Surface
14 Surface
20 Section
22 Edge
24 Gauge
30 Section
32 Edge
34 Edge
36 Gauge
38 Gauge
39 Slot(s)
40 Section
42 Edge
44 Line
46 Portion
48 Portion
50 Edge
52 Connector
60 Section
62 Edge
64 Edge
66 Protrusion
68 Tip
70 Connector
80 Data code
82 Reference
84 Table
86 Table
88 Table
CD1 Circumferential direction
CD2 Circumferential direction

What is claimed is:

1. An electrofusion pipe measuring device, comprising:
a first section comprising a first edge and a second edge;
a second section extending from the first section, the second section including a third edge arranged perpendicular to the first edge and a fourth edge; and,
a third section rotatably connected to one of the first section and the second section, the third section including a fifth edge and a sixth edge.

2. The electrofusion pipe measuring device as recited in claim 1, wherein the second section further comprises:
a first portion;
a second portion; and,
a line separating the first portion and the second portion, wherein the sixth edge is operatively arranged to overlay the first portion, the second portion, or the line.

3. The electrofusion pipe measuring device as recited in claim 2, wherein in a first state, the fifth edge is arranged adjacent to the third edge.

4. The electrofusion pipe measuring device as recited in claim 3, wherein in a second state, after the third section is rotated in a first circumferential direction to engage a pipe end, the sixth edge overlays one of the first portion, the line, and the second portion.

5. The electrofusion pipe measuring device as recited in claim 2, wherein the line is arranged at an angle relative to the third edge.

6. The electrofusion pipe measuring device as recited in claim 5, wherein the line is arranged at a three-degree angle relative to the third edge.

7. The electrofusion pipe measuring device as recited in claim 1, wherein the second edge comprises a gauge including a plurality of slots extending from the second edge.

8. The electrofusion pipe measuring device as recited in claim 7, wherein each slot of the plurality of slots comprises a different width than every other slot of the plurality of slots.

9. The electrofusion pipe measuring device as recited in claim 1, wherein the first edge comprises a measuring gauge.

10. The electrofusion pipe measuring device as recited in claim 1, further comprising a fourth section rotatably connected to one of the first section and the second section, the fourth section comprising:
a seventh edge;
an eight edge; and,
a protrusion extending from the eight edge, the protrusion including a tip.

11. The electrofusion pipe measuring device as recited in claim 10, wherein the seventh edge is operatively arranged to overlay a gauge on the second section.

12. The electrofusion pipe measuring device as recited in claim 11, wherein, in a first state, the tip is arranged adjacent to the fourth edge.

13. The electrofusion pipe measuring device as recited in claim 12, wherein, in a second state, when the fourth section has been rotated in a first circumferential direction such that the tip engages an indentation in a radially outward facing surface of a pipe, the protrusion extends beyond the fourth edge and the tip is not aligned with the fourth edge.

14. The electrofusion pipe measuring device as recited in claim 1, further comprising a data code operatively arranged to communicate information.

15. A measuring device for a pipe to be used for electrofusion, the measuring device comprising:
a first section comprising a first edge and a second edge;
a second section extending from the first section, the second section including:
a third edge arranged perpendicular to the first edge;
a fourth edge;
a miter gauge including a first portion, a second portion, and a line separating the first portion and the second portion; and,
a pit gauge;
a third section rotatably connected to one of the first section and the second section, the third section including a fifth edge and a sixth edge, the sixth edge operatively arranged to overlay the first portion, the line, or the second portion; and,
a fourth section rotatably connected to one of the first section and the second section, the fourth section including:
a seventh edge operatively arranged to overlay the pit gauge; and,
an eight edge comprising a protrusion extending therefrom.

16. The measuring device as recited in claim 15, wherein the line is arranged at an angle relative to the third edge.

17. The measuring device as recited in claim 15, wherein:
the second edge comprises a plurality of slots; and,
each slot of the plurality of slots comprises a different width than every other slot of the plurality of slots.

18. The measuring device as recited in claim 15, wherein the third section is operatively arranged to be rotated in a first circumferential direction such that the fifth edge engages an end of the pipe and the sixth end indicates an extent of a miter of the end.

19. The measuring device as recited in claim 15, wherein the fourth section is operatively arranged to be rotated in a first circumferential direction such that the protrusion engages an indentation in an outer surface of the pipe and the seventh edge indicates the extend of the indentation.

20. A measuring device for a pipe to be used for electrofusion, the measuring device comprising:
a first section comprising a first edge and a second edge, the second edge including a plurality of slots;
a second section comprising:
a third edge arranged perpendicular to the first edge;
a fourth edge;
a miter gauge; and,
a pit gauge;
a third section rotatably connected to one of the first section and the second section, the third section comprising a fifth edge and a sixth edge, the sixth edge operatively arranged to overlay the miter gauge; and,
a fourth section rotatably connected to one of the first section and the second section, the third section comprising:
a seventh edge including a protrusion extending therefrom; and,
an eighth edge operatively arranged to overlay the pit gauge.
